(19) United States
(12) Patent Application Publication
(10) Pub. No.: US 2009/0034989 A1
(43) Pub. Date: Feb. 5, 2009

(54) LIGHT SIGNAL PROCESSING DEVICE AND LIGHT SIGNAL STORING DEVICE

(75) Inventors: Daisuke HAYASHI, Shiga (JP); Masayuki SUEHIRO, Musashino-shi (JP); Morio WADA, Musashino-shi (JP)

Correspondence Address: SUGHRUE-265550, 2100 PENNSYLVANIA AVE. NW, WASHINGTON, DC, 20037-3213, US

(73) Assignee: YOKOGAWA ELECTRIC CORPORATION, Musashino-shi (JP)

(21) Appl. No.: 12/144,920

(22) Filed: Jun. 24, 2008

(30) Foreign Application Priority Data
Jun. 28, 2007 (JP) 2007-169863

(51) Int. Cl. H04B 10/06

(52) U.S. Cl. 398/208

(57) ABSTRACT

There is provided a light signal processing device. The light signal processing device includes a label recognition circuit and an electro-absorption optical switch. The label recognition circuit includes: a plurality of photodiodes coupled to each other in parallel; a resonant tunneling diode coupled in series with the photodiodes; and a data buffer coupled to a connection point between the photodiodes and the resonant tunneling diode. The label recognition circuit is adapted to latch an optical bit signal inputted into the photodiodes. The electro-absorption optical switch is driven directly by an output signal outputted from the label recognition circuit.

This application is based on and claims priority from Japanese Patent Application No. 2007-169863, filed on Jun. 28, 2007, the entire contents of which are hereby incorporated by reference.

### BACKGROUND

1. Technical Field

The present disclosure relates to a light signal processing device and a light signal storing device and, more particularly, to a light signal processing device using a resonant tunneling diode (RTD) and a light signal storing device using this light signal processing device.

2. Related Art

In the optical packet communication system, the packet routing process of executing route control of an optical packet at each node based on address information of the optical packet is carried out. In the current packet routing process at each node, a light signal is converted into an electric signal, then the packet routing process is applied to the electric signal, and then the electric signal is converted again into the light signal and thus the light signal is outputted.

Meanwhile, in such packet routing process, address information of the optical packet must be recognized precisely at a high speed.

Therefore, the following devices have been proposed. For example, JP-A-2004-328304 discloses the light signal processing device using the photodiodes and the resonant tunneling diode. Also, JP-A-2007-025368 discloses the optical storing element and the optical storing device capable of reading and writing the light signal at any timing at a high speed

FIG. 3 is a circuit diagram showing an example of the light signal processing device using photodiodes (referred to as “PDs” hereinafter) and the resonant tunneling diode (referred to as “RTD” hereinafter) in the related art, and FIG. 4 is a view of an example of the I-V characteristic of the RTD.

In FIG. 3, PDs 1 and 2 are coupled in parallel in the same direction. Their anodes are coupled to a power supply line of −V2, and their cathodes are coupled to a connection point between series-coupled resistors R1 and R2. One end of the RTD is coupled to a connection point between the cathodes of the PDs 1 and 2 and the resistors R1 and R2. The other end is coupled to a power supply line of +V3. A rectangular signal of 0 to −V1 (V1>0) is input into the one end of the resistor R1 as a gate signal Vin of the RTD. A data buffer (referred to as “DB” hereinafter) as a limiting amplifier is coupled to one end of the resistor R2, and a voltage Vout is output via this DB. V1 and V3 are set to adequate values to execute following operations.

In FIG. 4, when the gate signal Vin is OFF (=0), a load straight line corresponds to “a”, and the RTD is in an A state. A slope of the load straight line “a” is decided by the resistors R1, R2, and the intercept is decided by V3.

When the gate signal Vin is ON (=−V1), a load straight line corresponds to “b”, and the RTD is in a B state. A slope of the load straight line “b” is decided by the resistors R1, R2, and the intercept is decided by V1, V3.

When a light is incident on both PDs 1 and 2 simultaneously in a situation that the gate signal Vin is in an ON state, the load straight line is shifted upward by a sum of optical currents and corresponds to “c”. At this time, the RTD exceeds a peak value of the current and shifts to a high voltage state C. This transition occurs at a very high speed of about 2 ps to 3 ps in accordance with the characteristic of the RTD.

Then, even when either or both of the PDs 1 and 2 are turned OFF, the load straight line corresponds to “b” as far as the gate signal Vin is still in the ON state. Thus, the RTD remains in a high voltage state D and is kept in a latch state.

When the gate signal Vin is turned OFF, the load straight line corresponds to “a”, and at this time the RTD goes back to a low voltage state A for the first time.

Accordingly, if a threshold value of the DB coupled in the later stage is set adequately, low voltage (A, B) states and high voltage (C, D) states of the RTD are converted into a binary digital signal respectively.

Based on such an operational principle of the RTD, this device is operated as the optical switch as shown hereunder, and the label recognition of the optical packet is carried out.

FIG. 5 is an explanatory view of a configuration of the optical packet. Each packet is constructed by a head bit, an address portion and a data portion. A total length of one packet is fixed, and a “zero bit” with an adequate length is provided between respective bits.

The lengths of the optical fibers provided to input the optical packet to PD1 and PD2 are changed respectively such that the optical packet is inputted into the PDs with a certain time difference. For example, in discriminating whether or not the first bit of the address portion is set to a logical 1, on the assumption that this bit indicates an address of the optical packet, a length difference corresponding to a time difference between the head bit and the first bit of the address portion is provided between the optical fibers. This corresponds to a serial-parallel conversion of the optical packet.

When the optical packet whose address bit is set to a logical 1 is input while the gate signal Vin is ON, a state of the RTD is latched on the high voltage side based on the above principle. Even after the address portion of the optical packet passed, the RTD still remains in the high voltage state, so long as the gate signal is ON.

A latching operation of such the RTD is performed at a very high speed. Therefore, even though the optical packet is constructed by an NRZ signal (25 ps/bit) of 40 Gbps, for example, the address written in the optical packet can be latched.

In configuration of the circuit in FIG. 3, when a light is incident simultaneously on two PD1 and PD2, a simple sum of the optical currents exceeds a peak current value of RTD and thus RTD is latched in the high voltage state. That is, the circuit in FIG. 3 constitutes the “optical AND circuit”.

Also, in the circuit in FIG. 3, the RTD is latched by performing AND-operation on the head bit and the address bit of interest. That is, it is recognized only whether or not the address bit of interest is set to a logical 1.

Also, in the optical packet in FIG. 5, an empty bit interval corresponding to several bits is provided between the head bit and the address portion and between the address portion and the data portion respectively. Then, in the circuit of FIG. 3, the gate signal is turned ON only when the address portions of the optical packets being inputted to have a certain time difference are inputted into both PDs. Thus, it can be prevented that the RTD is latched by performing AND-operation on the head bit and the bit except the address bit.

The state of the RTD is digitized by the DB in the later stage. This digitized signal can be used in route control of the optical switch element, as shown in FIG. 6.

In FIG. 6, the optical packet being inputted via an optical fiber FB is inputted into two system. In one system, the optical packet is input into an optical switch OS via a delay fiber DF. In another system, the optical packet is input into a label recognition circuit LR. In the label recognition circuit LR, when a light is incident simultaneously on two PD1 and PD2, a simple sum of the optical currents exceeds a peak current value of the RTD and thus the RTD is latched in the high voltage state, like the optical NAND circuit in FIG. 3.

The optical packet being input into the label recognition circuit LR is then inputted into two the PD1 and PD2. As described above, when a logical 1 is set on the address bit of interest of the optical packet, the AND-operation of the head bit and this address bit is performed, and then the RTD latches an output of this AND-operation.

The signal latched by the RTD is input into a control circuit CTL as the voltage signal, then this voltage signal is converted into the current signal, and then the current signal is input into the optical switch element OS of current-injection type. This switch element OS has output ports of two “through”/“drop” systems. The “through”/“drop” is switched/controlled as the output port of the optical packet in response to ON/OFF of the current signal.

However, according to the above configuration, although the optical bit is latched at a very high speed by the RTD, the optical switch element OS is driven/controlled by the current signal that is converted from the voltage signal by the control circuit CTL. Therefore, the high-speed performance characteristic of the RTD is not utilized adequately. Also, a circuit space, a parts cost, and power consumption are increased on account of the provision of the control circuit CTL.

### SUMMARY

Exemplary embodiments of the present invention address the above disadvantages and other disadvantages not described above. However, the present invention is not required to overcome the disadvantages described above, and thus, an exemplary embodiment of the present invention may not overcome any of the problems described above.

It is an aspect of the present invention to provide a light signal processing device and a light signal storing device, capable of switching a light signal at a high speed with a relatively small and inexpensive configuration.

According to one or more aspects of exemplary embodiments of the present invention, a light signal processing device comprises: a label recognition circuit including: a plurality of photodiodes coupled to each other in parallel; a resonant tunneling diode coupled in series with the photodiodes; and a data buffer coupled to a connection point between the photodiodes and the resonant tunneling diode, the label recognition circuit being adapted to latch an optical bit signal inputted into the photodiodes; and an electro-absorption optical switch driven directly by an output signal outputted from the label recognition circuit.

According to one or more aspects of exemplary embodiments of the present invention, the electro-absorption optical switch includes first and second electro-absorption optical switches, and the first and second electro-absorption optical switches are driven directly by the same output signal outputted from the label recognition circuit.

According to one or more aspects of exemplary embodiments of the present invention, a light signal processing device comprises: a label recognition circuit including: a plurality of photodiodes coupled to each other in parallel; a resonant tunneling diode coupled in series with the photodiodes; and a data buffer coupled to a connection point between the photodiodes and the resonant tunneling diode, the label recognition circuit being adapted to latch an optical bit signal inputted into the photodiodes; first and second electro-absorption optical switches each driven directly by an output signal outputted from the label recognition circuit; and a feedback loop for feeding back an output light outputted from the first electro-absorption optical switch to an input side of the first electro-absorption optical switch via an optical amplifier.

According to the exemplary embodiments of the present invention, the optical switch is driven directly by the output signal of the label recognition circuit. As a result, it is possible to provide the light signal processing device and the light signal storing device that are able to make full use of the high-speed performance characteristic of RTD and are small in size.

Other aspects and advantages of the invention will be apparent from the following description, the drawings and the claims.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a circuit diagram according to an embodiment of the present invention;

FIG. 2 is a circuit diagram according to another embodiment of the present invention;

FIG. 3 is a circuit diagram illustrating an example of a light signal processing device using photodiodes and a resonant tunneling diode in the related art;

FIG. 4 is a view of an example of the I-V characteristic of RTD;

FIG. 5 is a configurative view of an example of the optical packet in the related art; and

FIG. 6 is an explanatory view of route control of an optical switch element in the related art.

### DETAILED DESCRIPTION

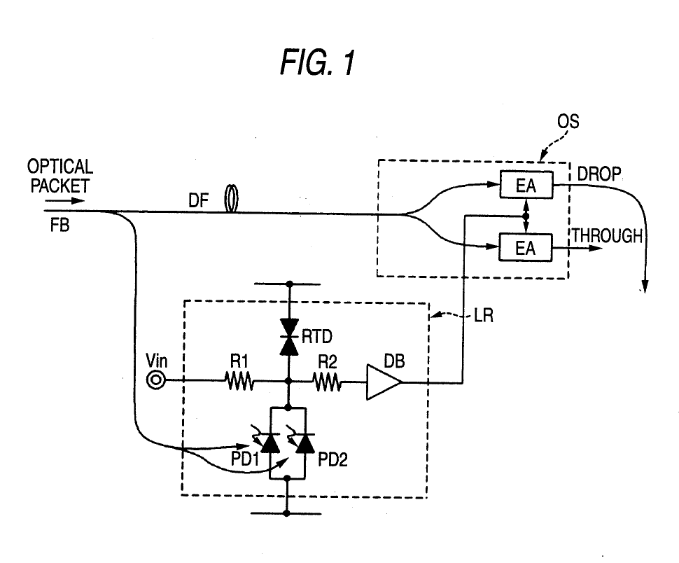

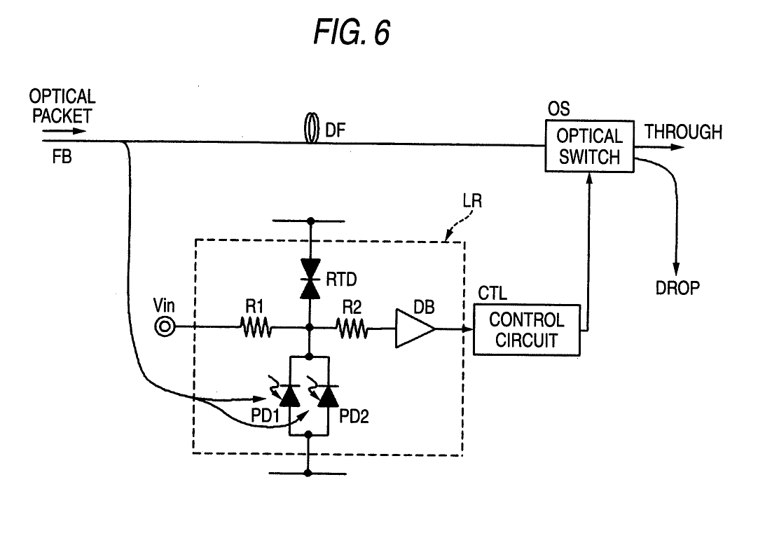

Exemplary embodiments will be described with reference to the drawings hereinafter. FIG. 1 is a circuit diagram according to an embodiment of the present invention, and the same reference symbols are affixed to the portions that are common in FIG. 6. The optical switch OS used in FIG. 1 is an optical switch of electro absorption (EA) type and can be driven directly by a relatively low voltage such as an output voltage of DB that constitutes the label recognition circuit LR. In the optical switch OS, two systems of “through” and “drop” are provided. The two-system optical switch will be referred to as an EA hereinafter. The optical packet passing through the delay fiber DF is input into two systems (i.e., the two-system optical switch EA). Also, the common output signal of the label recognition circuit LR is directly inputted into the two-system optical switch EA without the control circuit shown in FIG. 6.

In the above configuration, when the light signal is latched by the label recognition circuit LR, one optical switch EA (e.g., the “through” system) is turned ON and the optical packet is outputted from this “through” system whereas another optical switch EA (e.g., the “drop” system) is turned OFF and the optical packet is not outputted from this “drop” system. This state is held until the latch of the label recognition circuit LR is reset.

When the latch of the label recognition circuit LR is reset, the one optical switch EA (e.g., the “through” system) is turned OFF and the optical packet is not outputted from this “through” system whereas the other optical switch EA (e.g., the “drop” system) is turned ON and the optical packet is outputted from this “drop” system.

According to the configuration of FIG. 1, the two-system optical switch EA is driven directly by the output signal of the label recognition circuit LR used in common. Therefore, unlike the configuration in FIG. 6, the high-speed characteristic of RTD is not impaired due to the control circuit. As a result, the high-speed switching operation is carried out in a condition that the fast performance characteristic of RTD is used efficiently.

Also, it is not necessary to provide the control circuit for driving the two-system optical switch EA. Therefore, a circuit space, a parts cost, and power consumption can be reduced as the whole light signal processing device, and a size reduction can be achieved.

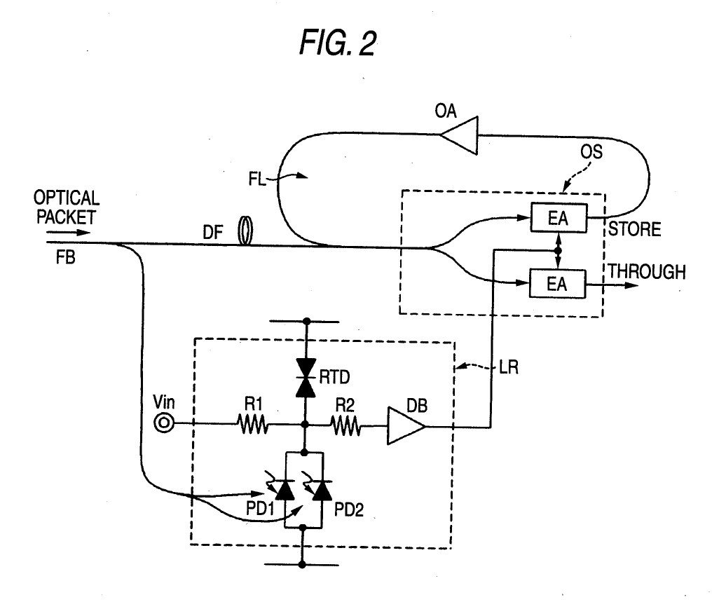

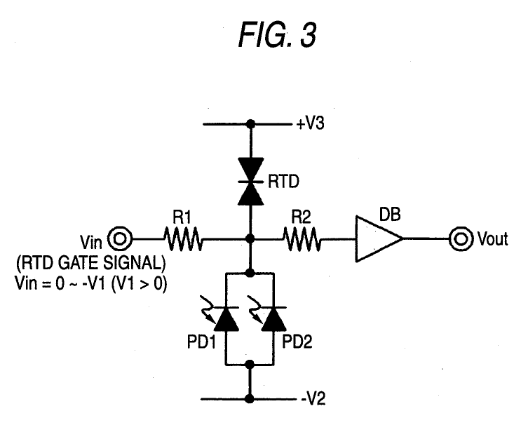

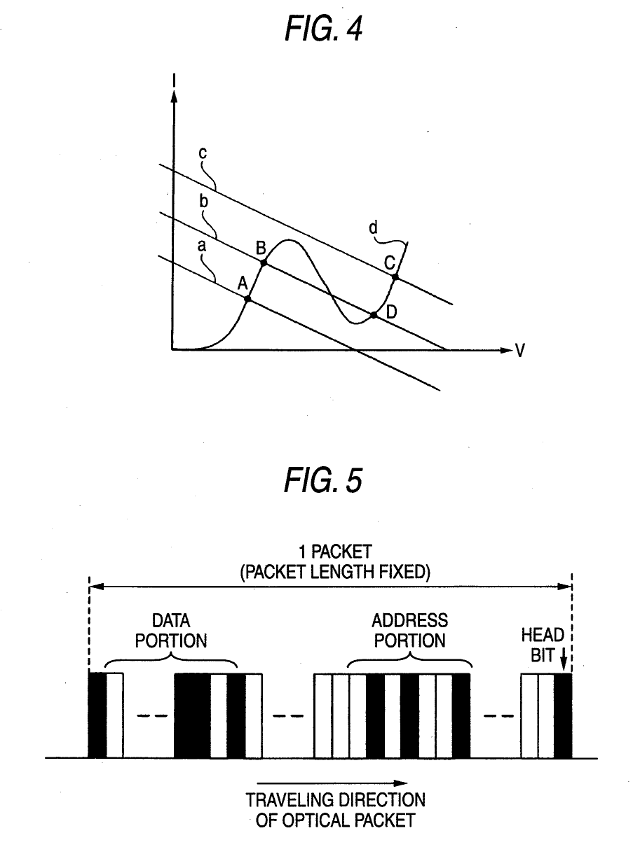

FIG. 2 is a circuit diagram according to another embodiment of the present invention, and the same reference symbols are affixed to the portions that are common in FIG. 1. In FIG. 2, a feedback loop FL for feeding back the output light to the input side via an optical amplifier OA is provided to the one optical switch EA (e.g., the “store” system). The light signal processing device adapted to function as a light signal storing device will be described hereunder.

In the configuration in FIG. 2, when the light signal is latched by the label recognition circuit LR, one optical switch EA (e.g., the “store” system) is turned ON and the optical packet is circulated in the feedback loop FL whereas another optical switch EA (e.g., the “through” system) is turned OFF and the optical packet is not outputted from the “through” system. This state is held until the latch of the label recognition circuit LR is reset. Since the optical packet is circulated in the feedback loop FL, an optical power of the optical packet is attenuated by the optical switch EA. In this case, an attenuation of the optical power caused when the optical packet passes through this optical switch EA is compensated by the amplification of the optical amplifier OA.

When the latch of the label recognition circuit LR is reset, one optical switch EA (e.g., the “store” system) is turned OFF and the circulation of the optical packet in the feedback loop FL is stopped whereas the other optical switch EA (e.g., the “through” system) is turned ON and the optical packet is outputted from the “through” system.

That is, according to the configuration in FIG. 2, the optical packet is circulated in the feedback loop FL and is not outputted to the outside in a period that the label recognition circuit LR is latched, while the circulation of the optical packet in the feedback loop FL is stopped and the optical packet is outputted to the outside when the latch of the label recognition circuit LR is released. Therefore, this light signal processing device functions as the light signal storing device that stores the optical packet in response to a latch period of the label recognition circuit LR.

As described above, according to the exemplary embodiments of the present invention, there is provided the light signal processing device and the light signal storing device that are able to make full use of the fast performance characteristic of RTD and are small in size As a result, these devices are suitable for all equipments and systems associated with the optical communication of which the storage of the optical packet for any time is demanded, including the optical label recognition on the optical packet switch.

While the present invention has been shown and described with reference to certain exemplary embodiments thereof, other implementations are within the scope of the claims. It will be understood by those skilled in the art that various changes in form and details may be made therein without departing from the spirit and scope of the invention as defined by the appended claims.

What is claimed is:

1. A light signal processing device, comprising:
a label recognition circuit including:
a plurality of photodiodes coupled to each other in parallel;
a resonant tunneling diode coupled in series with the photodiodes; and
a data buffer coupled to a connection point between the photodiodes and the resonant tunneling diode, the label recognition circuit being adapted to latch an optical bit signal inputted into the photodiodes; and
an electro-absorption optical switch driven directly by an output signal outputted from the label recognition circuit.

2. The light signal processing device according to claim 1, wherein the electro-absorption optical switch includes first and second electro-absorption optical switches, and
the first and second electro-absorption optical switches are driven directly by the same output signal outputted from the label recognition circuit.

3. A light signal processing device, comprising:
a label recognition circuit including:
a plurality of photodiodes coupled to each other in parallel;
a resonant tunneling diode coupled in series with the photodiodes; and
a data buffer coupled to a connection point between the photodiodes and the resonant tunneling diode, the label recognition circuit being adapted to latch an optical bit signal inputted into the photodiodes;
first and second electro-absorption optical switches each driven directly by an output signal outputted from the label recognition circuit; and
a feedback loop for feeding back an output light outputted from the first electro-absorption optical switch to an input side of the first electro-absorption optical switch via an optical amplifier.
